(19) United States
(12) Patent Application Publication
(10) Pub. No.: US 2015/0326684 A1
(43) Pub. Date: Nov. 12, 2015

(54) SYSTEM AND METHOD OF ACCESSING AND CONTROLLING A CO-PROCESSOR AND/OR INPUT/OUTPUT DEVICE VIA REMOTE DIRECT MEMORY ACCESS

(71) Applicant: Diablo Technologies Inc., Ottawa (CA)

(72) Inventors: Michael L. Takefman, Nepean (CA); Bart Trojankowski, Ottawa (CA); Maher Amer, Nepean (CA); Riccardo Badalone, St.Lazare (CA)

(73) Assignee: Diablo Technologies Inc., Ottawa (CA)

(21) Appl. No.: 14/271,838

(22) Filed: May 7, 2014

(51) Int. Cl. H04L 29/08; H04L 29/06

(52) U.S. Cl. CPC H04L 67/2842; H04L 67/40

(57) ABSTRACT

A method of controlling a remote computer device of a remote computer system over a remote direct memory access (RDMA) is disclosed. According to one embodiment, the method includes establishing a connection for remote direct memory access (RDMA) between a local memory device of a local computer system and a remote memory device of a remote computer system. A local command is sent from a local application that is running on the local computer system to the remote memory device of the remote computer system via the RDMA. The remote computer system executes the local command on the remote computer device.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED FIELD

The present disclosure relates in general to techniques for accessing a co-processor and/or input/output (hereafter “CPIO”) device on one computer system from another computer system, and in particular, to a system and method of accessing and controlling a CPIO device via remote direct memory access.

### BACKGROUND

Computers in a distributed and networked environment may have similar or different hardware configurations. For example, a first computer may have a CPIO device (e.g., NVIDIA's CUDA™ parallel computing device) dedicated to performing intensive computations while a second computer may not have such a device. Traditionally, if a user of a second computer wants to run an application on the first computer to make use of the CPIO device, the user has to run the application at the terminal of the first computer, or if the first computer is at a remote location, via a remote protocol (e.g., VPN). If the computers are configured for distributed computing or processing, the application may send a data processing request and the data to be processed from the first computer to the second computer. Sending the request and data generally includes making kernel calls (e.g., I/O calls) to the local network interface card (NIC), copying data from the application memory space (herein also “application space”) into the kernel memory space (herein also “kernel space”), and writing the copied data from the kernel space to the NIC (e.g., via DMA).

The second computer processes the received request by writing the data received from the NIC into the second computer's kernel space and copying the data from the kernel space to the application space (and then to the CPIO device memory if it contains memory) so that the application on the second computer can process the data using the CPIO device. Servicing kernel calls and copying data between the kernel space and the application space imposes significant overhead from the main processor (e.g., CPU) and the operating system kernel of both computers. There exists a need for a system and method of accessing and controlling a CPIO device on one computer from another computer that involves less overhead from the CPU and the operating system kernel.

Remote direct memory access (RDMA) is a technology that enables data exchange between the application spaces of two networked computers having RDMA-enabled NICs (RNICs). Known as zero-copying, an RDMA data exchange bypasses the kernels of both computers and lets an application issue commands to the NIC without having to execute a kernel call. An RDMA request is issued from the application space to a local RNIC and over the network to a remote RNIC and requires no kernel involvement. Thus, RDMA reduces the number of context switches between kernel space and application space while handling network traffic.

### SUMMARY

A method of controlling a remote computer device of a remote computer system over a remote direct memory access (RDMA) is disclosed. According to one embodiment, the method includes establishing a connection for remote direct memory access (RDMA) between a local memory device of a local computer system and a remote memory device of a remote computer system. A local command is sent from a local application that is running on the local computer system to the remote memory device of the remote computer system via the RDMA. The remote computer system executes the local command on the remote computer device.

A system that is configured to control a remote computer device of a remote computer system over a remote direct memory access (RDMA) is also disclosed. The system includes a local computer system and a remote computer system. The local computer system includes a local memory device. The remote computer system is connected to the local computer system over a computer network. The remote computer system includes a remote computer device. The local computer system is configured to run a local application that sends a local command to the remote computer system and accesses the remote memory device via the RDMA.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWING

The accompanying drawings, which are included as part of the present specification, illustrate various embodiments and together with the general description given above and the detailed description of the various embodiments given below serve to explain and teach the principles described herein.

FIG. 1 illustrates a block diagram of an exemplary computer architecture for implementing a CPIO device that allows access and control via RDMA, according to one embodiment;

FIG. 2 illustrates a block diagram of an exemplary implementation of a CPIO storage device that includes non-volatile memory, according to one embodiment;

FIG. 3 illustrates a block diagram of another exemplary implementation of a CPIO storage device that includes non-volatile memory, according to one embodiment;

FIG. 4 illustrates a block diagram of an exemplary implementation of a CPIO processing device that includes a processing engine, according to one embodiment;

FIG. 5 illustrates a block diagram of exemplary RDMA-enabled computer systems implementing a CPIO device in their main memory system, according to one embodiment;

FIG. 6 illustrates another block diagram of exemplary RDMA-enabled computer systems implementing a CPIO device in their main memory system, according to one embodiment;

FIG. 7 illustrates a flow diagram of exemplary operations for writing to a CPIO device on one computer from another computer via RDMA, according to one embodiment;

FIG. 8 illustrates exemplary operations for transferring a command and/or data to a CPIO device on one computer from another computer via RDMA, according to one or more embodiments;

FIG. 9 illustrates exemplary operations for communicating status information of a CPIO device on one computer to another computer via RDMA, according to one or more embodiments;

FIG. 10 illustrates exemplary operations for transferring read data from a CPIO device on one computer to another computer via RDMA, according to one or more embodiments;

FIG. 11 illustrates a flow diagram of exemplary RDMA operations for writing to a CPIO device on one computer from another computer via RDMA, according to one embodiment; and

FIG. 12 illustrates a flow diagram of exemplary RDMA operations for reading from a CPIO device on one computer from another computer via RDMA, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a system and method of accessing and controlling a co-processor and/or I/O device via RDMA. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure describes a system and method of accessing and controlling a CPIO device on one computer from another computer via RDMA and relates to co-pending and commonly-assigned U.S. patent application Ser. No. 13/303,048 entitled “System and Method of Interfacing Co-processors and Input/Output Devices via a Main Memory System,” incorporated herein by reference. U.S. patent application Ser. No. 13/303,048 describes a system and method for implementing CPIO devices on a computer main memory system to provide enhanced input/output (I/O) capabilities and performance.

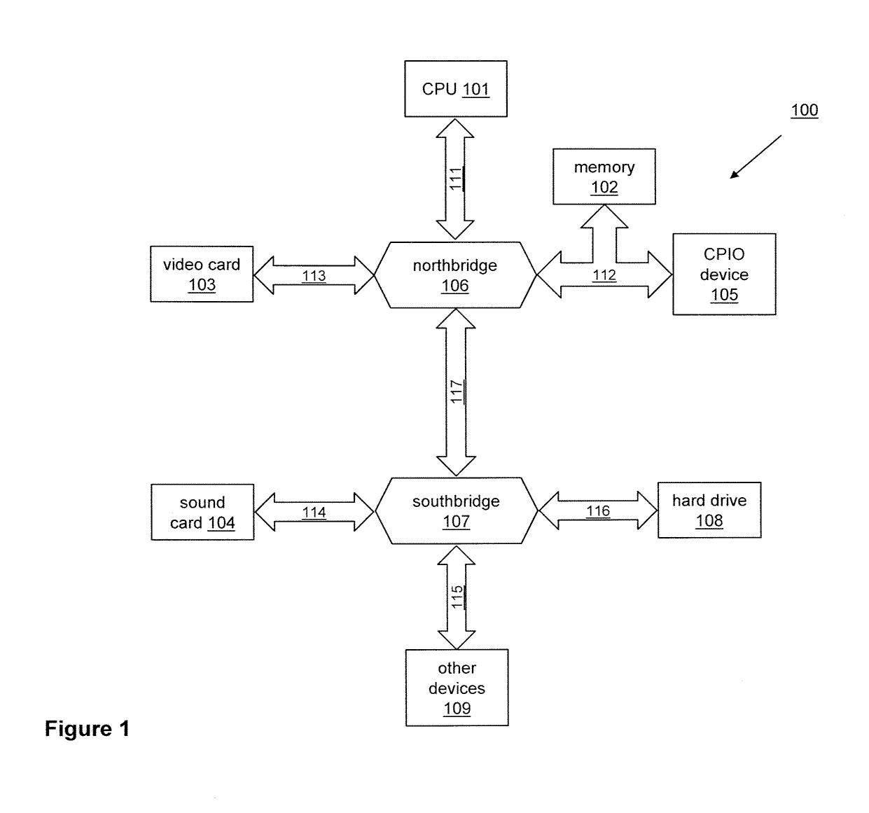

FIG. 1 illustrates a block diagram of an exemplary computer architecture for implementing a CPIO device that allows access and control via RDMA, according to one embodiment. Computer system 100 includes a CPU (central processing unit) 101, a main memory unit (e.g., DRAM) 102, and CPIO devices including a video card 103, a sound card 104, a hard drive 108, and any generic CPIO device 105. These components are connected together via buses on a motherboard (not shown). CPU 101, main memory unit 102, and video card 103 are connected via an FSB (front-side bus) 111, a main memory bus 112, and a PCIe (peripheral component interconnect express) bus 113, respectively, to a northbridge 106. The northbridge 106 generally refers to a chip in a chipset of the motherboard that connects high speed buses.

Slower buses, including the PCI bus 114, the USB (universal serial bus) 115, and the SATA (serial advanced technology attachment) bus 116 are usually connected to a southbridge 107. The southbridge 107 generally refers to another chip in the chipset that is connected to the northbridge 106 via a DMI (direct media interface) bus 117. The southbridge 107 manages the information traffic between CPIO devices that are connected via the slower buses. For example, the sound card 104 typically connects to the system 100 via the PCI bus 114. Storage drives, such as the hard drive 108, typically connect via the SATA bus 116. A variety of other devices 109, ranging from keyboards to mp3 music players, may connect to the system 100 via the USB 115.

Similar to the main memory unit 102 (e.g., DRAM), the generic CPIO device 105 connects to a memory controller in the northbridge 106 via the main memory bus 112. For example, the generic CPIO device 105 may be inserted into a dual in-line memory module (DIMM) memory slot. Because the main memory bus 112 generally supports higher bandwidths (e.g., compared to the SATA bus 116), the exemplary computer architecture of FIG. 1 connecting the generic CPIO device 105 to the main memory bus eliminates or alleviates I/O bottlenecks that would otherwise limit the I/O performance of the generic CPIO device 105. Furthermore, as will be shown later, connecting the generic CPIO device 105 to the main memory bus 112 allows the generic CPIO device 105 to be accessed and controlled via RDMA. RDMA has traditionally been used to transfer data between the main memories of two computers. RDMA has not been previously used to access and control a CPIO device on one computer from another computer.

While FIG. 1 illustrates each of the block components as discrete components, it is contemplated that some of the components may be combined or integrated with one or more other components. For example, the CPUs produced by INTEL® may include a northbridge or southbridge as part of the CPU.

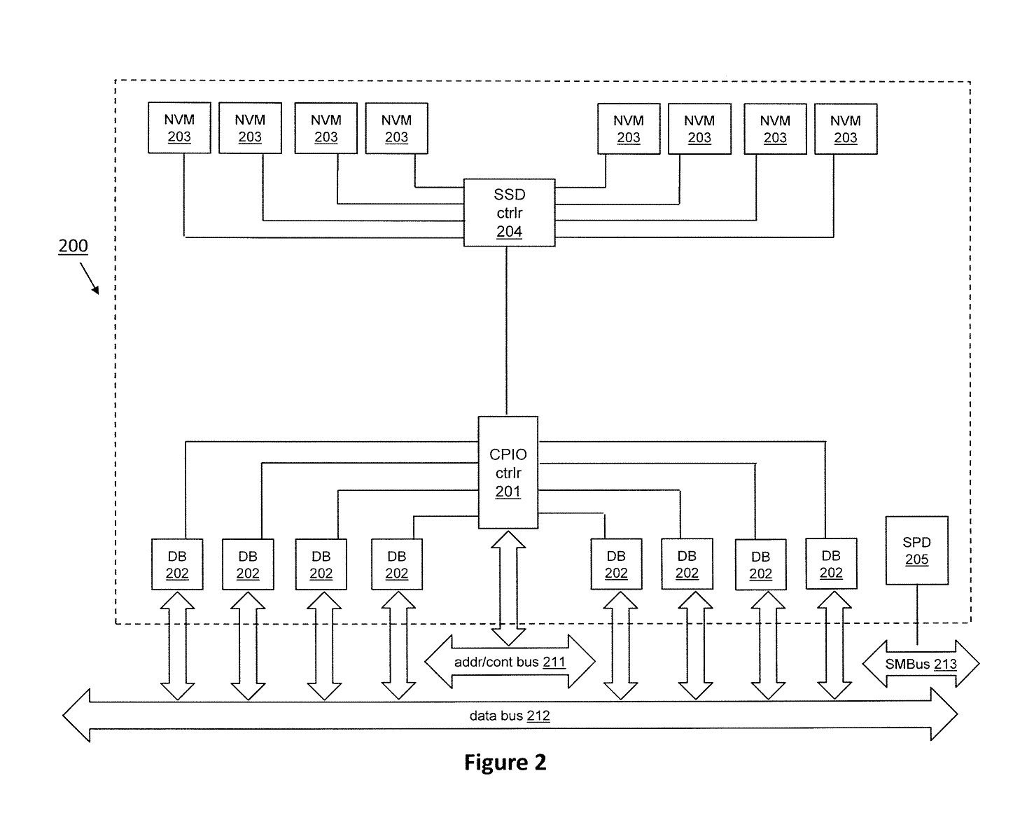

A CPIO device may include any device. According to one embodiment, a CPIO device receives and processes data from a host computer system. The received data may be stored, modified by the CPIO device, and/or used by the CPIO device to generate new data, wherein the stored, modified, and/or new data is sent back to the host computer system. FIG. 2 illustrates a block diagram of an exemplary implementation of a CPIO storage device that includes non-volatile memory, according to one embodiment. The CPIO storage device 200 is configured to interface to a computer system's main memory controller and includes a CPIO controller 201, a number of data buffer devices 202, a rank of non-volatile memory (NVM) devices 203, an SSD controller 204, and a serial presence detect (SPD) 205.

The CPIO controller 201 provides a memory mapped interface so that a software driver can control the CPIO storage device 200. The CPIO controller 201 also includes control circuitry for the data buffer devices 202 and an interface (e.g., SATA and PCIE) to the SSD controller 204. The SPD 205 stores information about the CPIO storage device 200, such as its size (e.g., number of ranks of memory), data width, manufacturer, speed, and voltage and may be accessed via a system management bus (SMBus) 213. The SSD controller 204 manages the operations of the NVM devices 203, such as accessing (e.g., reading, writing, erasing) the data in the NVM devices 203. The CPIO storage device 200 connects to the computer system's address/control bus 211 and main memory bus 212 via the CPIO controller 201.

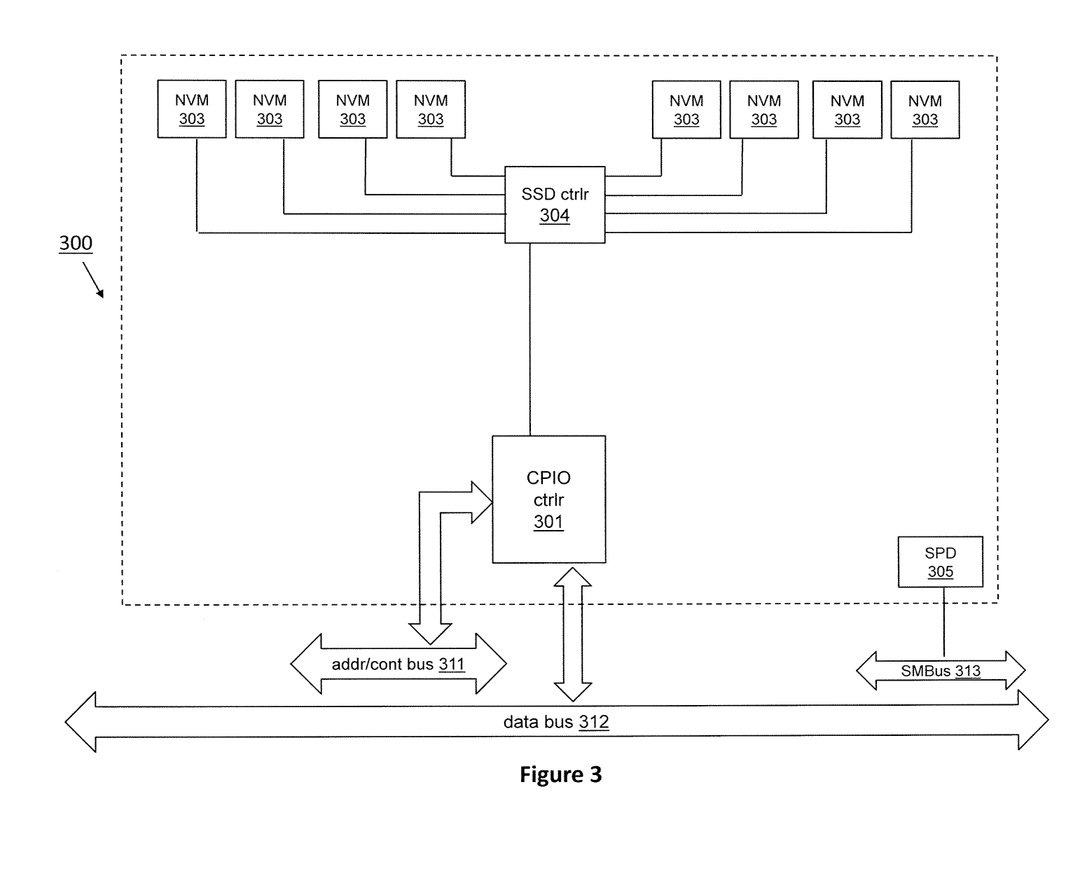

In this embodiment, the data buffer devices 203 buffer the connection between the CPIO storage device's (200) on-DIMM memory bus and the main memory bus 212. According to one embodiment, such as the embodiment illustrated by FIG. 3, the on-DIMM memory bus may connect directly to the main memory bus 212 without going through data buffer devices. Because the CPIO storage device 200 does not include a rank of DRAM devices, it provides more room for NVM devices. However, as shown below, BIOS changes may need to be implemented to bypass a memory test at BIOS boot (e.g., disable the memory test).

The BIOS is a set of firmware instructions that is run by the computer system to set up the hardware and to boot into an operating system when it first powers on. After the computer system powers on, the BIOS accesses the SPD 205 via the SMBus 213 to determine the number of ranks of memory in the CPIO storage device 200. The BIOS then typically performs a memory test on each rank in the CPIO storage device 200. The CPIO storage device 200 may fail the memory test because the test expects DRAM-speed memory to respond to its read and write operations during the test. Although the CPIO storage device 200 may respond to all memory addresses at speed, it generally aliases memory words. This aliasing may be detected by the memory test as a bad memory word.

FIG. 3 illustrates a block diagram of another exemplary implementation of a CPIO storage device that includes non-volatile memory, according to one embodiment. The CPIO storage device 300 is configured to interface to a computer system's main memory controller and includes a CPIO controller 301, NVM devices 302, an SSD controller 304, and an SPD 305. The CPIO storage device 300 connects to the computer system's address/control bus 311 and main memory bus 312 via the CPIO controller 301. Varying from the embodiment of FIG. 2, the CPIO storage device's (300) on-DIMM memory bus connects the CPIO controller 301 directly to the main memory bus 312.

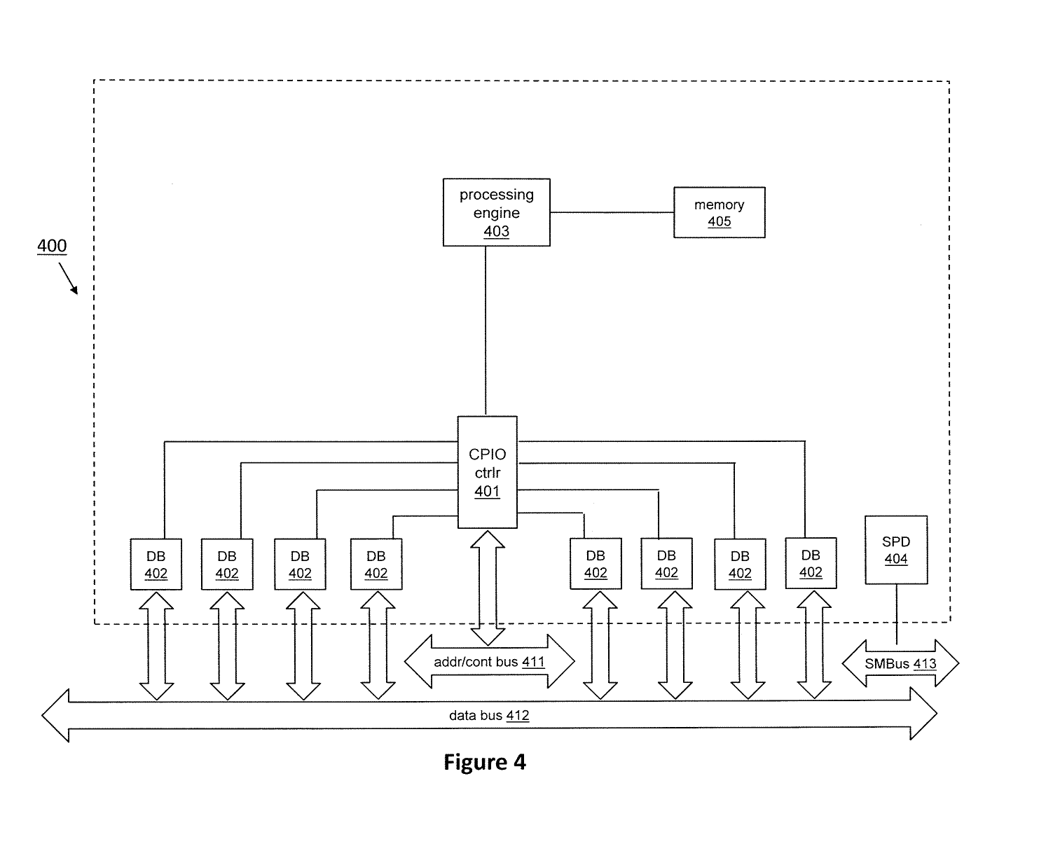

FIG. 4 illustrates a block diagram of an exemplary implementation of a CPIO processing device that includes a processing engine, according to one embodiment. The CPIO processing device 400 is configured to interface to a computer system's main memory controller and includes a CPIO controller 401, a number of data buffer devices 402, a processing engine 403, an SPD 404, and a memory device 405. The CPIO controller 401 provides a memory mapped interface so that a software driver can control the CPIO processing device 400. The CPIO controller 401 also includes control circuitry for the data buffer devices 402 and an interface (e.g., SATA and PCIE) to the processing engine 403. The SPD 404 stores information about the CPIO processing device 400, such as its data width, manufacturer, speed, and voltage and may be accessed via an SMBus 413. The processing engine 403 processes data received from the computer system and provides processed results back to the computer system. The processing engine 403 may be a general-purpose microprocessor or an application specific processor, such as an image processor, a DSP processor, or a graphics processor. The CPIO processing device 400 connects to the computer system's address/control bus 411 and main memory bus 412 via the CPIO controller 401. The processing engine 403 also operatively connects to the memory device 405, which may contain volatile and/or non-volatile memory. In this embodiment, the data buffer devices 402 buffers the connection between the CPIO processing devices (400) on-DIMM memory bus and the main memory bus 412. According to one embodiment, the on-DIMM memory bus may connect directly to the main memory bus 412 without going through data buffer devices.

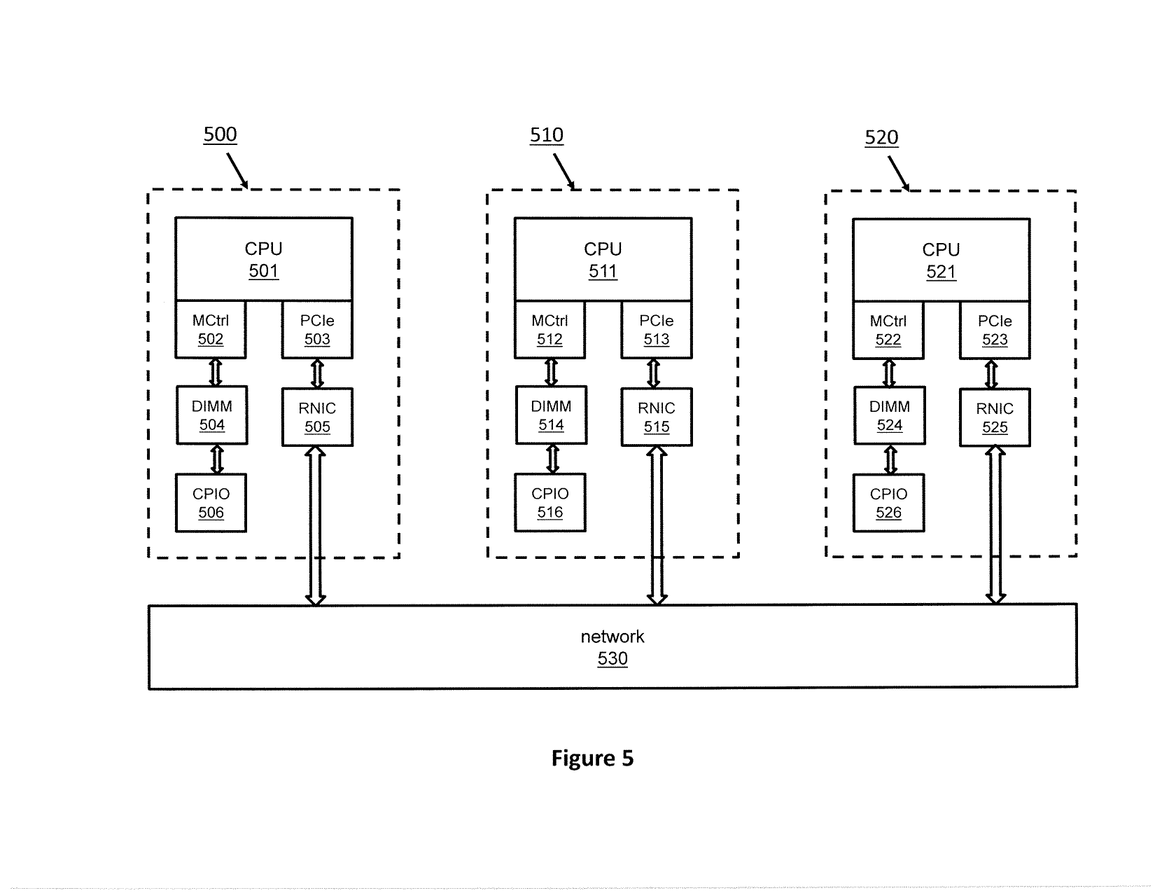

FIG. 5 illustrates a block diagram of exemplary RDMA-enabled computer systems implementing a CPIO device in their main memory system, according to one embodiment. Each of the computer systems 500, 510, and 520 are connected to a network 530 (e.g., 802.3 Ethernet) and include a CPU (501, 511, and 521), a main memory controller (502, 512, and 522), a PCIe bus controller (503, 513, and 523), a DIMM (e.g. DRAM) (504, 514, and 524), a RNIC (505, 515, and 525), and a CPIO device (506, 516, and 526) that has a DIMM interface. Because the CPIO devices (506, 516, and 526) are connected to each corresponding computer's main memory system via the memory controller (502, 512, and 522), RDMA operations from one computer to another computer may target the DIMM (504, 514, and 524) or the CPIO device (506, 516, and 526).

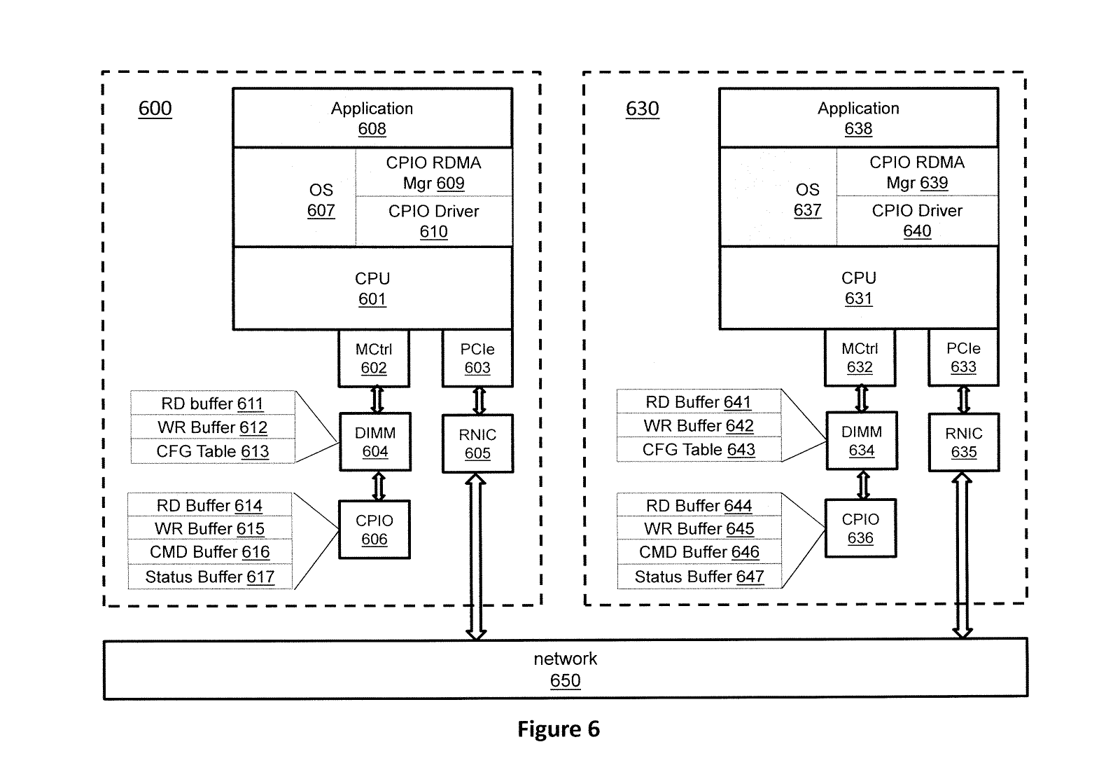

FIG. 6 illustrates another block diagram of exemplary RDMA-enabled computer systems implementing a CPIO device in their main memory system, according to one embodiment. Each of the computer systems 600 and 630 are connected to a network 650 (e.g., 802.3 Ethernet) and include a CPU (601 and 631), a main memory controller (602 and 632), a PCIe bus controller (603 and 633), a DIMM (e.g., DRAM) (604 and 634), a RNIC (605 and 635), and a CPIO device (606 and 636) that has a DIMM interface. The computer systems 600 and 630 are running an operating system (OS) (607 and 637), a software application (608 and 638), a CPIO RDMA manager (609 and 639), and a CPIO driver (610 and 640).

The software application 608 running on the computer system 600 may initiate an RDMA operation to access the CPIO device 636 on the computer system 630 by starting a negotiation through its RDMA manager 609 and CPIO driver 610 with the RDMA manager 639 and the CPIO driver 640 on computer 630. Vice versa, the software application 638 running on the computer system 630 may initiate an RDMA operation to access the CPIO device 606 on the computer system 600 by starting a negotiation through its RDMA manager 639 and CPIO driver 640. Each RDMA manager (609 and 639) sets up permissions and assigns address ranges for buffers on their respective computer systems (600 and 630) for communication via RDMA. For example, the RDMA manager 609 may set up a read buffer 611, a write buffer 612, and a configuration table 613 on the DIMM 604 and/or a read (RD) buffer 614, a write (WR) buffer 615, a command (CMD) buffer 616, and a status buffer 617 on the CPIO device 606. Where the buffers are set up may depend on the design of the CPIO device and the amount of buffer memory available. According to one embodiment, the RDMA manager allocates at least one command buffer for the exclusive use of the remote CPIO device.

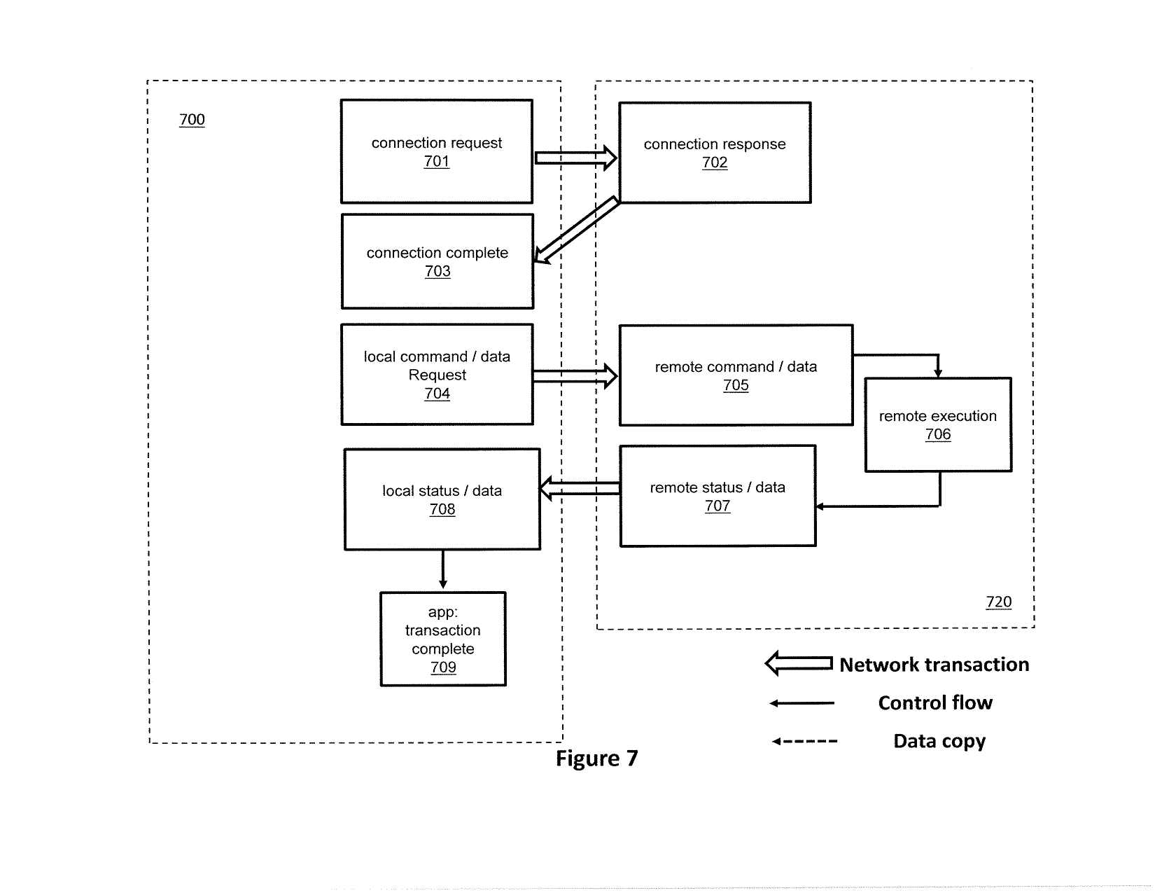

FIG. 7 illustrates a flow diagram of exemplary operations for writing to a CPIO device on one computer system from another computer system via RDMA, according to one embodiment. During a first stage of the operations, a local computer system 700 sends a connection request at 701 to a remote computer system 720. The remote computer system 720 responds to the first computer system 700 with a connection response at 702 and allocates buffers in its DRAM and/or CPIO internal memory. The local computer system determines that connection is complete at 703 when it receives the connection response. The local computer system 700 also allocates buffers in its DRAM and/or CPIO internal memory.

During a second stage of the operations, the local computer system 700 sends a command/data request to the remote computer system 720 at 704. For a WRITE command, the local system 700 also sends the data to be written to the CPIO device. The remote system 720 receives the command/data request at 705. The remote system 720 executes the command at 706 during a third stage of the operations.

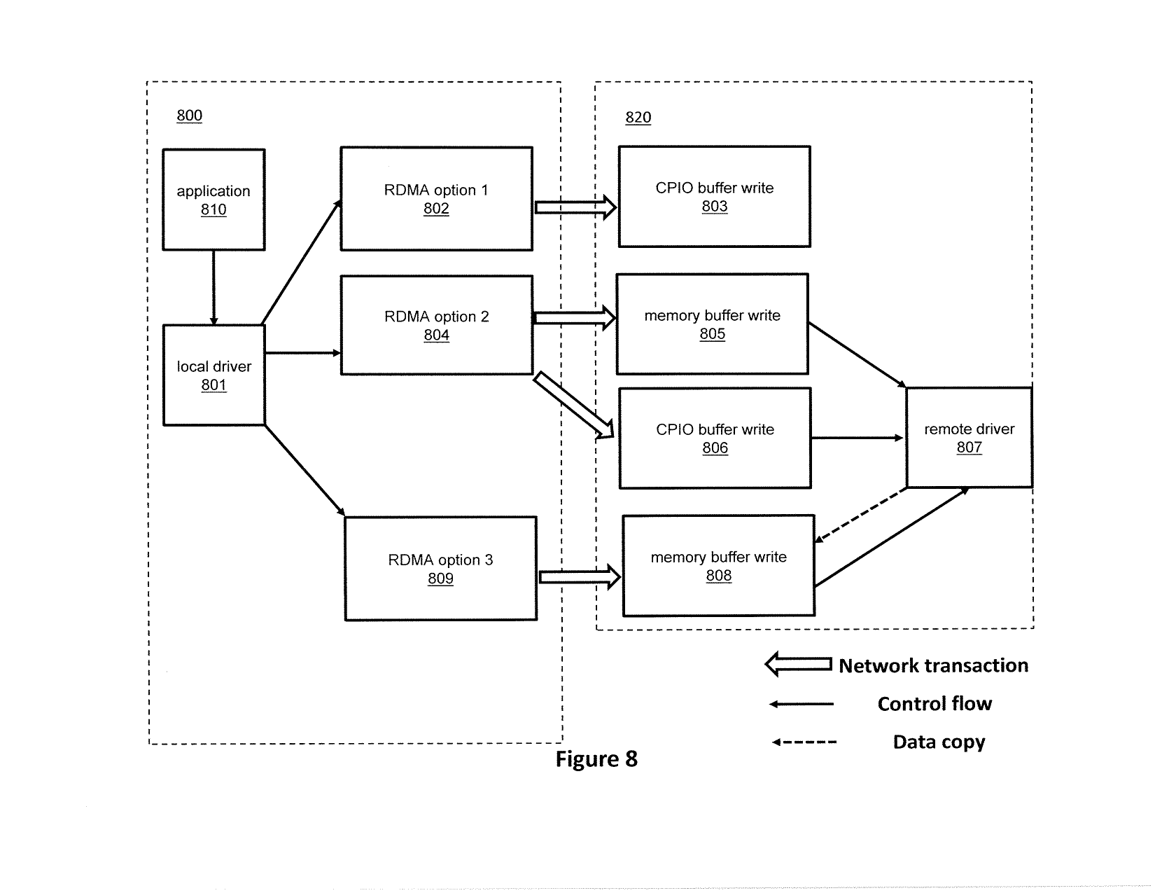

During a fourth stage of the operations, the remote computer system 720 sends status information (e.g., whether the command was successfully executed) 707 back to the local computer system 700. For a READ command, the read data is also transferred. The local system 700 receives the status information and/or data from the remote system 720 (at 708) and returns it to the local application that originated the command request (at 709). FIGS. 8 through 10 illustrate exemplary operations for completing stages two through four of the above-described operations. Multiple embodiments of the invention are contemplated, including implementing different permutations of the operations for each stage.

FIG. 8 illustrates exemplary operations for transferring a command and/or data to a CPIO device on one computer from another computer via RDMA, according to one or more embodiments. An application 810 on a local computer system 800 calls a driver 801 to send a command/data to a CPIO device on a remote computer system 820 via RDMA. The driver 801 may utilize one of the three options —802, 804, or 809—to transfer the command/data via RDMA. If the CPIO device on the remote computer system 820 has enough buffers such that one or more command and data buffers can be allocated, the local driver 801 targets the CPIO device directly (option 1 at 802) and writes to the CPIO buffers via RDMA at 803. Writing to the CPIO buffers directly via RDMA does not require setup from the remote driver 807. The command (and write data) is transferred to and automatically executed on the remote system 820.

If the CPIO device does not have enough buffers or is running in an interrupt driven state, the local driver 801 may send the command/data to the CPIO device using option 2 (804) or option 3 (809). Under option 2, the local driver 801 first sends the command (and data for a WRITE command) to the main memory (e.g., DRAM) on the remote system 820 via RDMA at 805. The local driver 801 then accesses the CPIO device via RDMA to cause an interrupt on the remote system 820 at 806. According to another embodiment, option 2 uses remote driver polling of status buffers in the remote CPIO device (as compared to an interrupt). The interrupt signals (or status buffer) to the remote driver 807 that a command/data has been written to the main memory. Under option 3, the local driver 801 also sends the command (and data for writes) to the main memory of the remote system 820 at 808. Unlike option 2 however, the local driver 801 does not have to cause an interrupt to signal the remote driver 807 because the remote driver 807 polls circular buffers in its main memory to detect and access any command/data written by the local system 800.

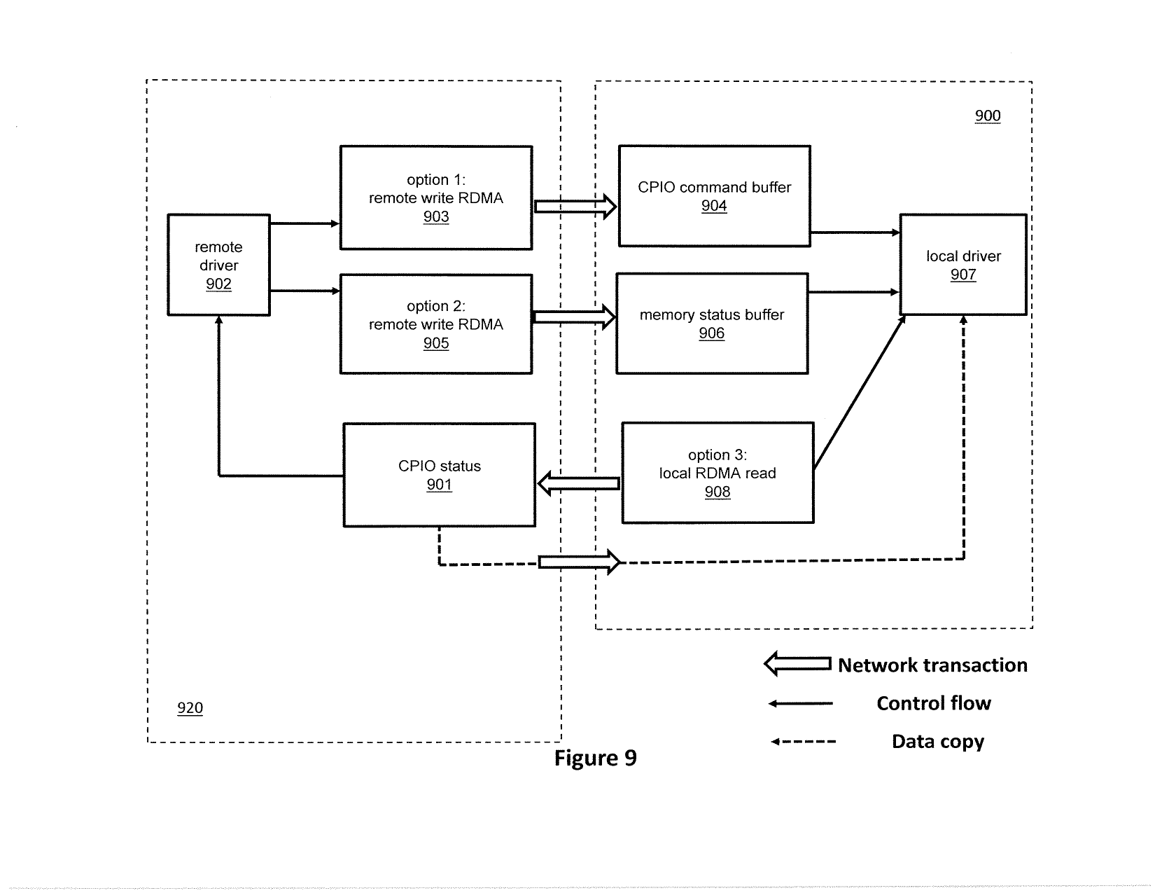

FIG. 9 illustrates exemplary operations for communicating status information of a CPIO device on one computer to another computer via RDMA, according to one or more embodiments. A remote system 920 may communicate the status information of its CPIO device to a local system 900 using one of three options —903, 905, or 908. Under the first option 903, a remote driver 902 reads the CPIO status 901 and transfers the status information to the CPIO command buffer 904 of the local system 900, which is then accessed by the local driver 907. Under the second option 905, the remote driver 902 reads the CPIO status 901 and transfers the status information to the memory status buffer 906 of the local system 900, which is then accessed by the local driver 907. Under the third option 908, the local driver 907 performs an RDMA read operation to read the status information directly from the CPIO device on the remote system 920.

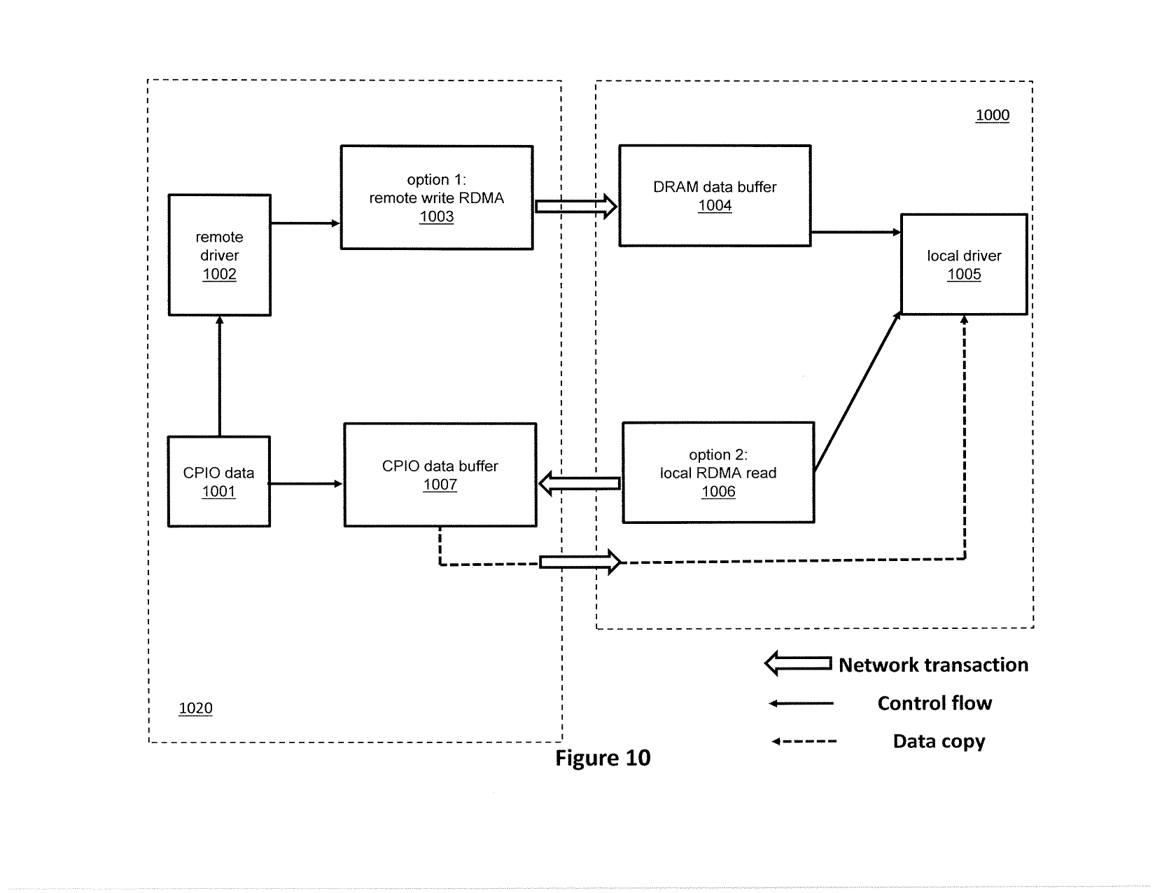

FIG. 10 illustrates exemplary operations for transferring CPIO data from a CPIO device on one computer to another computer via RDMA, according to one or more embodiments. A remote system 1020 may transfer CPIO data 1001 from its CPIO device to a local system 1000 using one of two options —1003 or 1006. Under the first option 1003, the remote driver 1002 performs an RDMA write operation to transfer the CPIO data 1001 to a DRAM buffer 1004 in the local system 1000. Under this option, the CPIO data 1001 may be transferred before transferring the status information. Under the second option 1006, the local driver 1005 performs an RDMA read operation to read the data directly from the CPIO device's data buffer 1007. In this case, because the local system 1000 performs the RDMA read operation when the status information indicates that the CPIO device's data buffer 1007 is ready (i.e., filled with the CPIO data), the remote system 1020 transfers the status information before transferring the CPIO data.

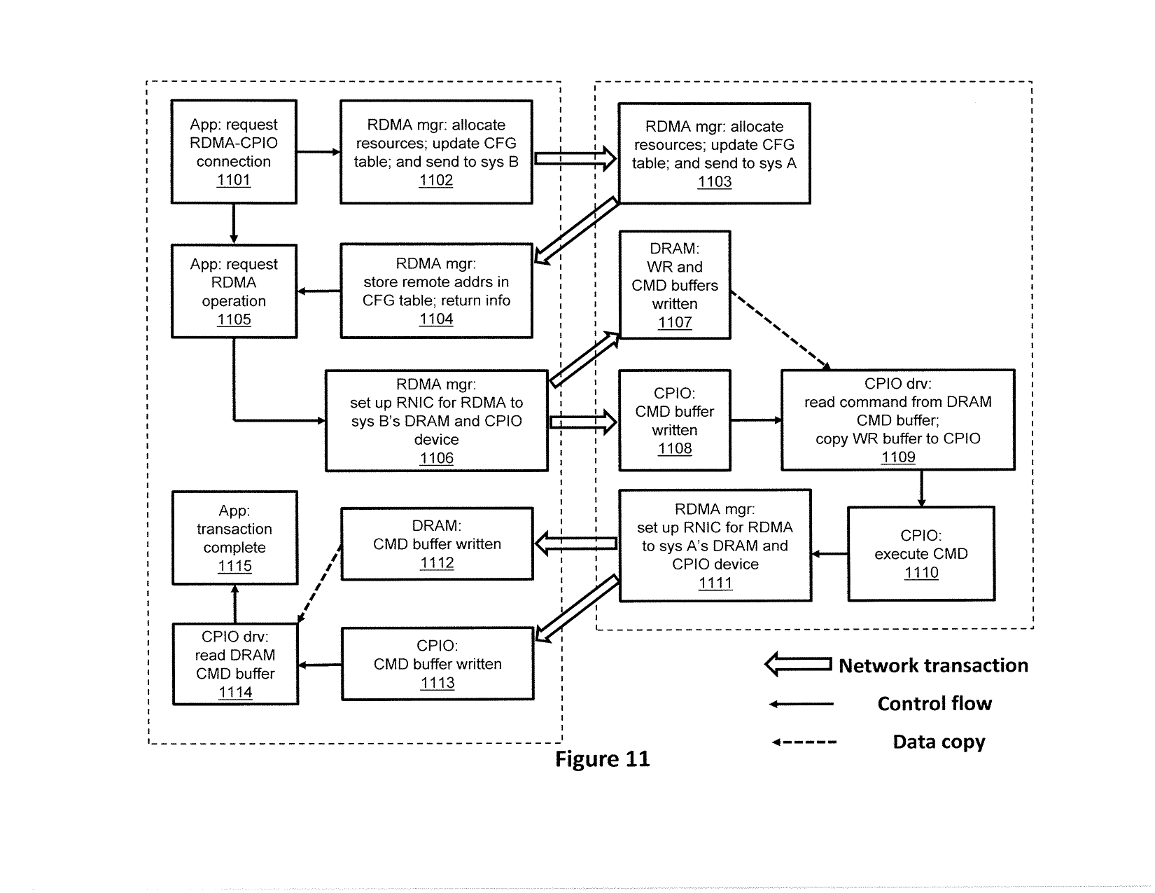

FIG. 11 illustrates a flow diagram of exemplary RDMA operations for writing to a CPIO device on one computer from another computer via RDMA, according to one embodiment. An application running on computer system A (“system A”) requests to establish an RDMA-CPIO connection for accessing a CPIO device of another computer system B (“system B”) at 1101. To simplify the following description, system A and its components are described as local, and computer system B and its components are described as remote. At 1102, the local RDMA manager allocates resources, such as buffers (e.g., read, write, command, and status buffers) on system A and stores the allocation information in its configuration (CFG) table. Allocation information may include addresses of the allocated resources. The local RDMA manager also sends its allocation information to system B. At 1103, the remote RDMA manager allocates resources on system B, stores the allocation information (including the local allocation information of system A) in its CFG table, and sends the allocation information to the local RDMA manager. The local and remote RDMA managers may allocate resources in their respective DRAM and/or CPIO device, depending on the memory availability of each device. In this embodiment, the CPIO driver may not be able to read from the CPIO device's CMD buffer. Thus, a CMD buffer is allocated in both the CPIO device and the DRAM, while the WR buffer is allocated in the DRAM.

At 1104, the local RDMA manager updates its CFG table to include the remote allocation information and an RDMA-CPIO connection is established. Operations 1101 through 1104 may not be performed if an RDMA-CPIO connection has been previously established, and an RDMA-CPIO operation may proceed directly to 1105.

At 1105, the local application makes a request to the local RDMA manager to write data to the remote CPIO device. The local RDMA manager sets up the local RNIC for RDMA operations to target the remote DRAM (e.g., main memory) and CPIO device at 1106. The local RDMA manager writes a data buffer to the WR buffer and a write command buffer to the CMD buffer of the remote DRAM via an RDMA operation at 1107. The local RDMA manager also writes a write command buffer to the CMD buffer of the remote CPIO device via another RDMA operation at 1108. The write command buffer in the remote CPIO device's CMD buffer serves as a doorbell command that the remote CPIO device's firmware uses to generate status information in its status buffer, which informs the remote CPIO driver that a command buffer has been received from system A.

The remote CPIO driver reads the write command buffer from the DRAM's CMD buffer at 1109 and copies the WR buffer to the CPIO device's memory space. The remote CPIO device executes the write command at 1110 (e.g., write the WR buffer into non-volatile memory storage). After completing the write command, the remote CPIO device informs the remote CPIO driver of its completion by generating status information in its status buffer. At 1111, the remote CPIO driver makes a request to the remote RDMA manager to set up the remote RNIC for RDMA operations to target the local CPIO device. The remote RDMA manager writes a command buffer to the local DRAM's CMD buffer (at 1112) and the local CPIO device's CMD buffer (at 1113) via RDMA operations. Writing to the local CPIO device's CMD buffer serves as a doorbell command that the local CPIO device's firmware uses to generate status information in its status buffer. The return command prompts the local CPIO driver to read the status command buffer from the local DRAM's CMD buffer at 1114. The local CPIO driver notifies the local application that the write operation to the remote CPIO device has been completed at 1115.

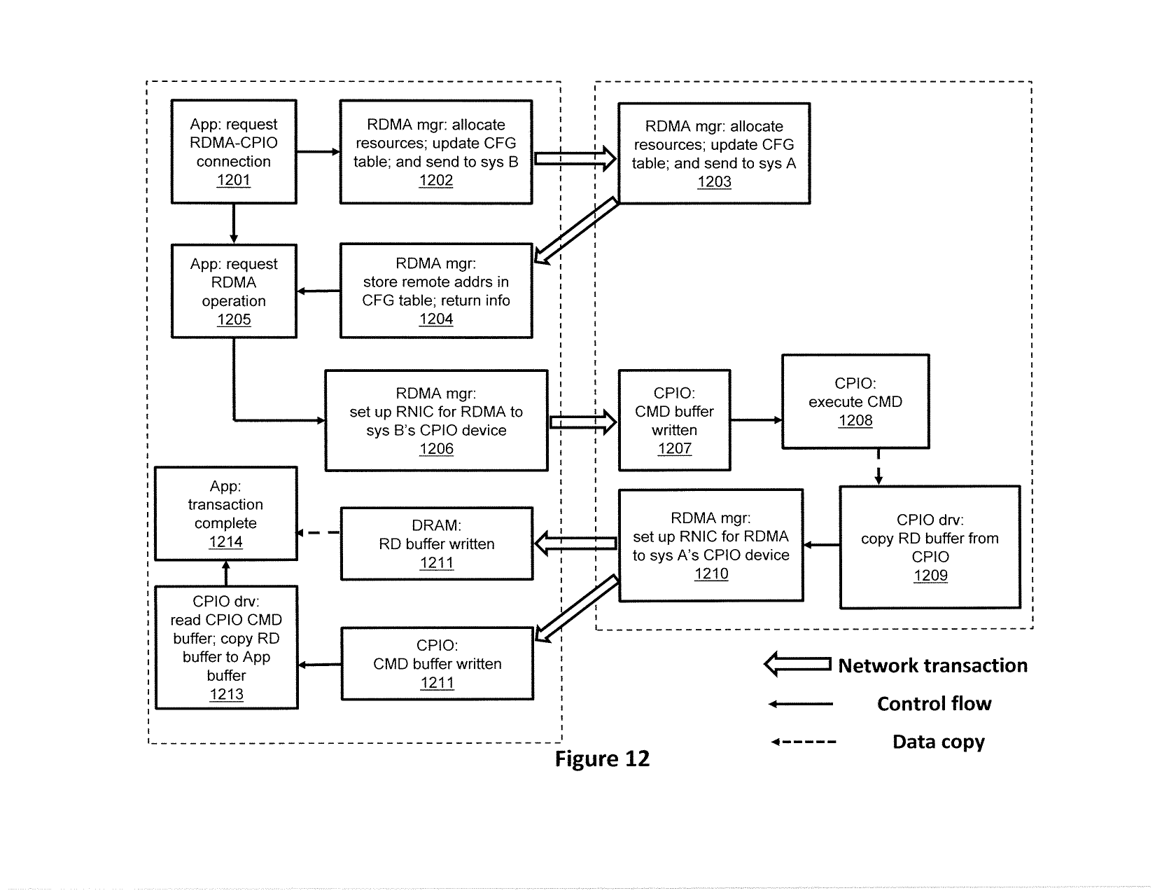

FIG. 12 illustrates a flow diagram of exemplary RDMA operations for reading from a CPIO device on one computer from another computer via RDMA, according to one embodiment. An application running on computer system “A” requests to establish an RDMA-CPIO connection for accessing a CPIO device of another computer system “B” at 1201. To simplify the following description, system A and its components are described as local, and computer system B and its components are described as remote. At 1202, the local RDMA manager allocates resources, such as buffers (e.g., read, write, command, and status buffers) on system A and stores the allocation information in its configuration (CFG) table. Allocation information may include addresses of the allocated resources. The local RDMA manager also sends its allocation information to system B. At 1203, the remote RDMA manager allocates resources on system B, stores the allocation information (including the local allocation information of system A) in its CFG table, and sends its allocation information to the local RDMA manager. The RDMA manager in this embodiment allocates a CMD buffer in remote CPIO device and an RD buffer in the remote DRAM.

At 1204, the local RDMA manager updates its CFG table to include the remote allocation information, and an RDMA-CPIO connection is established. Operations 1201 through 1204 may not be performed if an RDMA-CPIO connection has been previously established and an RDMA-CPIO operation may proceed directly to 1205.

At 1205, the local application makes a request to the local RDMA manager to write a read command buffer to the remote CPIO device. The local RDMA manager sets up the local RNIC for RDMA operations to target the remote CPIO device at 1206. The local RDMA manager writes a read command buffer to the CMD buffer of the remote DRAM via an RDMA operation at 1207. The remote CPIO device executes the read command at 908 (e.g., read data from non-volatile memory). After the remote CPIO device completes the read command, the remote CPIO driver copies the data read from the remote CPIO device into the remote DRAM's RD buffer at 1209. The remote CPIO driver also makes a request to the remote RDMA manager to set up the remote RNIC for RDMA operations to target the local CPIO device at 1210. The remote RDMA manager writes data from the remote DRAM's RD buffer to the local DRAM's RD buffer (at 1211) and a command buffer to the local CPIO device's CMD buffer (at 1212) via RDMA operations. At 1213, the local CPIO driver reads the command buffer from the local CPIO device's CMD buffer and copies the local DRAM's RD buffer to the local application's buffer. The command buffer informs the local CPIO driver that the read operation has been completed. The local CPIO driver notifies the local application of the completion at 1214.

FIGS. 11 and 12 illustrate just two of the possible embodiments for performing the transfer of commands, status and data between the local and remote systems and should not be construed to limit the scope of the teachings or claims.

The above example embodiments have been described hereinabove to illustrate various embodiments of implementing a system and method of accessing and controlling a CPIO device via remote direct memory access. Various modifications and departures from the disclosed example embodiments will occur to those having ordinary skill in the art. The subject matter that is intended to be within the scope of the invention is set forth in the following claims.

What is claimed:

1. A method of controlling a remote computer device of a remote computer system over a computer network, comprising:
establishing a connection for remote direct memory access (RDMA) between a local memory device of a local computer system and a remote memory device of a remote computer system;
sending a local command from a local application that is running on the local computer system to the remote memory device of the remote computer system via the RDMA; and
causing the remote computer system to execute the local command on the remote computer device.

2. The method of claim 1 further comprising receiving a status from the remote computer device over the computer network, wherein the status is generated based on remotely executing the local command on the remote computer system in response to the local command.

3. The method of claim 1, wherein the remote computer system has an RDMA manager for allocating a set of buffers in the remote memory device of the remote computer system.

4. The method of claim 1, wherein the local memory device comprises at least one of a read buffer, a write buffer, or a configuration table.

5. The method of claim 1, wherein the remote memory device of the remote computer system is a co-processor and/or input/output (CPIO) device connected to the remote computer system.

6. The method of claim 5, wherein the local computer system determines an RDMA option to access either a first set of buffers in the CPIO device or a second set of buffers in a main memory of the remote computer system based on a state of the remote computer device.

7. The method of claim 6, wherein the state of the remote computer device is determined by the availability of the first set of buffers allocated in the remote computer device or an interrupt state by the remote computer system.

8. The method of claim 6 wherein the remote memory device is the main memory of the remote computer system, and wherein the remote computer system accesses the main memory by an interrupt via the RDMA.

9. The method of claim 6 further comprising allowing a remote driver of the remote computer system to poll a circular buffer, and detecting and accessing a command or data written by the local computer system.

10. A system comprising:
a local computer system comprising a local memory device; and
a remote computer system connected to the local computer system over a computer network, the remote computer system comprising a remote memory device,
wherein the local computer system is configured to run a local application to send a local command to the remote computer system and access the remote memory device of the remote computer system via a remote direct memory access (RDMA).

11. The system of claim 10, wherein the local computer system is further configured to receive a status from the remote computer device over the computer network, wherein the status is generated based on remotely executing the local command on the remote computer system in response to the local command.

12. The system of claim 10, wherein the remote computer system has an RDMA manager configured to allocate a set of buffers in the remote memory device of the remote computer system.

13. The system of claim 10, wherein the first set of buffers comprise at least one of a read buffer, a write buffer, or a configuration table.

14. The system of claim 10, wherein the remote memory device of the remote computer system is a co-processor and/or input/output (CPIO) device connected to the remote computer system.

15. The system of claim 14, wherein the local computer system is further configured to determine an RDMA option to access either a first set of buffers in the CPIO device or a second set of buffers in a main memory of the remote computer system based on a state of the remote computer device.

16. The system of claim 15, wherein the state of the remote computer device is determined by the availability of the first set of buffers allocated in the remote computer device or an interrupt state by the remote computer system.

17. The system of claim 15, wherein the remote memory device is the main memory of the remote computer system, and wherein the remote computer system is configured to access the main memory by interrupt via the RDMA.

18. The system of claim 15, wherein the remote driver of the remote computer system is configured to poll a circular buffer, and detect and access a command or data written by the local computer system.
